(19) United States
(12) Patent Application Publication
(10) Pub. No.: US 2013/0231850 A1
(43) Pub. Date: Sep. 5, 2013

(54) CONTROL APPARATUS FOR VEHICULAR INTERNAL COMBUSTION ENGINE

(71) Applicant: Nobuyuki Taki, Toyota-shi (JP)

(72) Inventor: Nobuyuki Taki, Toyota-shi (JP)

(73) Assignee: TOYOTA JIDOSHA KABUSHIKI KAISHA, Toyota-shi, Aichi-ken (JP)

(21) Appl. No.: 13/884,720

(22) PCT Filed: Nov. 10, 2011
(86) PCT No.: PCT/IB2011/002650

§ 371 Date: May 10, 2013

(30) Foreign Application Priority Data
Nov. 18, 2010 (JP) 2010-257780

(51) Int. Cl. F02D 45/00

(52) U.S. Cl. CPC F02D 45/00
USPC 701/112

(57) ABSTRACT

A control apparatus for a vehicle, includes a condition that parking assist control not being performed as a stop condition of an internal combustion engine in automatic stop control, and prohibits automatic stop control of the automatic transmission while parking assist control is being executed.

### BACKGROUND OF THE INVENTION

1. Field of the Invention

The invention relates to a control apparatus for a vehicle. More particularly, the invention relates to a control apparatus for a vehicle, that performs automatic stop/start control of an internal combustion engine according to the driving situation.

2. Description of Related Art

In recent years, there has been an increase in the number of internal combustion engines that perform so-called idling stop control that automatically stops the internal combustion engine when a predetermined stop condition, such as the vehicle being stopped, is satisfied, and automatically starts the internal combustion engine when a predetermined start condition is satisfied, in order to reduce both fuel consumption and exhaust gas emissions.

Japanese Patent Application Publication No. 2000-120464 (JP-A-2000-120464), for example, describes technology that automatically stops an internal combustion engine when the vehicle speed is zero, a brake pedal is being depressed, an accelerator pedal is not being depressed, and a state-of-charge (SOC) of a battery is equal to or greater than a predetermined value, and then restarts the internal combustion engine in response to the accelerator pedal being depressed and the like.

In recent years, some vehicles are also provided with parking assist apparatuses that assist with parking. For example, Japanese Patent Application Publication No. 2008-279980 (JP-A-2008-279980) describes technology that assists with parking by calculating a parking path to a target parking position based on an image captured by a back monitor camera, a steering angle, and a vehicle speed, and controlling the steering angle to realize that parking path when parking.

When an internal combustion engine that performs idling stop control is mounted in a vehicle provided with a parking assist apparatus such as that described above, the internal combustion engine may stop due to the stop condition being satisfied even though parking assist is in the middle of being performed. Therefore, the internal combustion engine may stop against the intention of the driver, resulting in a decrease in drivability.

Also, the internal combustion engine may not start immediately even if there is a request for parking assist while the internal combustion engine is in an automatically stopped state. Therefore, the internal combustion engine may remain stopped against the intention of the driver, resulting in a decrease in drivability.

### SUMMARY OF THE INVENTION

The invention provides a control apparatus for a vehicle that, in a vehicle provided with a parking assist apparatus and an internal combustion engine that performs idling stop control, inhibits a decrease in drivability by inhibiting the internal combustion engine from stopping, or remaining stopped, against the intention of a driver, while parking assist is being performed.

A first aspect of the invention relates to a control apparatus for a vehicle, that includes a parking assist apparatus that assists with parking of the vehicle, and an automatic stopping device that automatically stops an internal combustion engine based on a predetermined stop condition, and that gives priority to parking assist control when there are requests to perform both of these controls. That is, a vehicle control apparatus for a vehicle, that includes a parking assist apparatus that assists with parking of the vehicle, and an automatic stopping device that automatically stops an internal combustion engine based on a predetermined stop condition, does not automatically stop the internal combustion engine when the parking assist apparatus is performing parking assist.

Also, the control apparatus for a vehicle according to the first aspect may also include a parking assist switch for starting parking assist, that is provided in the parking assist apparatus. The control apparatus may be such that it does not automatically stop the internal combustion engine when the parking assist switch is turned on.

Also, with the control apparatus for a vehicle described above, when a predetermined period of time or longer has passed or the vehicle has travelled a predetermined distance or more after the parking assist switch has been turned on, the control apparatus may automatically stop the internal combustion engine based on another stop condition, regardless of whether the parking assist switch is on or off.

A second aspect of the invention relates to a control apparatus for a vehicle, that includes a parking assist apparatus that assists with parking of the vehicle, and a restarting device that returns an internal combustion engine from an automatically stopped state, based on a predetermined restart condition, and that, when there is a request to perform parking assist when the internal combustion engine is in the automatically stopped state, restarts the internal combustion engine.

Also, the control apparatus for a vehicle according the second aspect may also include a parking assist switch for starting parking assist, that is provided in the parking assist apparatus, and may restart the internal combustion engine when the parking assist switch is turned on.

Also, the control apparatus for a vehicle described above may be such that it does not restart the internal combustion engine when a predetermined restart prohibited condition is satisfied, even if there is a request to perform parking assist.

The control apparatus for a vehicle according to the first aspect enables a decrease in drivability to be inhibited by inhibiting an internal combustion engine from stopping against the intention of the driver while parking assist is being performed, in a vehicle provided with a parking assist apparatus and an internal combustion engine that performs idling stop control.

Also, the control apparatus for a vehicle according to the second aspect enables a decrease in drivability to be inhibited by inhibiting an internal combustion engine from remaining stopped regardless of whether there is a request for parking assist, in a vehicle provided with a parking assist apparatus and an internal combustion engine that performs idling stop control.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a system block diagram of a parking assist apparatus according to an example embodiment of the invention;

FIG. 2 is a system block diagram of an internal combustion engine that performs idling stop control according to the example embodiment of the invention;

FIG. 3 is a flowchart illustrating automatic stop control according to the example embodiment of the invention; and

FIG. 4 is a flowchart illustrating restart control according to the example embodiment of the invention.

### DETAILED DESCRIPTION OF EMBODIMENTS

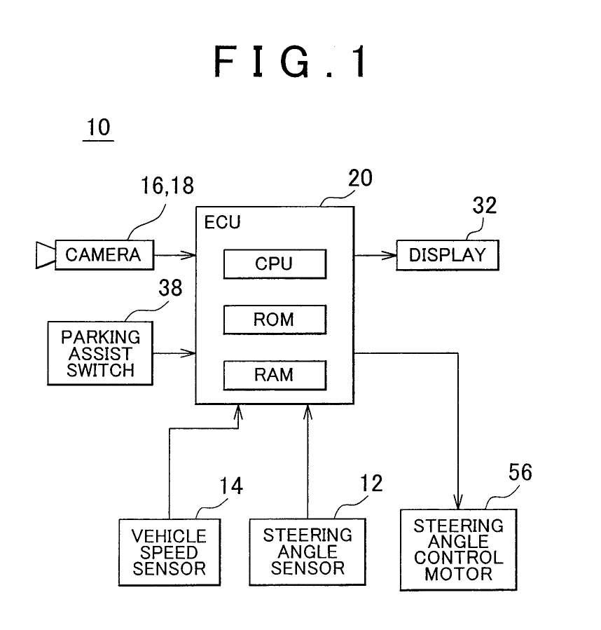

The system structure of a parking assist apparatus 10 according to an example embodiment will now be described with reference to FIG. 1. The parking assist apparatus 10 is structured around an electronic control unit 20 (hereinafter referred to as “ECU 20”). A back monitor camera 16 and a front monitor camera 18, a parking assist switch 38, a vehicle speed sensor 14, and a steering angle sensor 12, and the like are connected to an input portion of the ECU 20. Also, a display 32 and a steering angle control motor 56 and the like are connected to an output portion of the ECU 20.

The back monitor camera 16 includes an imaging element such as a CCD or COMS. This back monitor camera 16 is mounted near the center of a rear portion of the vehicle, for example, and captures an image of a predetermined area in back of the vehicle. That is, light entering the back monitor camera 16 is converted to a digital image signal, which is then sent to the ECU 20 as a rear image.

The front monitor camera 18 includes an imaging element such as a CCD or COMS. This front monitor camera 18 is mounted near a rearview mirror, for example, and captures an image of a predetermined area in front of the vehicle. That is, light entering the front monitor camera 18 is converted to a digital image signal, which is then sent to the ECU 20 as a front image.

The parking assist switch 38 is provided inside a vehicle cabin, and is able to be operated by a driver. The parking assist switch is normally off. When the parking assist switch is turned on in response to an operation by the driver, the parking assist apparatus 10 starts parking assist.

The vehicle speed sensor 14 is a sensor that detects the speed of the vehicle. A vehicle speed sensor that is mounted on a wheel of the vehicle and generates a pulse signal according to the wheel speed may be used. Also, the steering angle sensor 12 is a sensor that detects a steering angle of a steering wheel.

The display 32 is formed by a visual display unit such as a liquid crystal display or a touch panel display that has a touch switch provided on a liquid crystal display. The display 32 may be shared with a navigation device mounted in the vehicle.

The steering angle control motor 56 is provided on a steering column or steering gear box, and rotates a steering shaft according to the rotational angle thereof.

Next, a parking assist routine executed by the ECU 20 according to this example embodiment will be described. The ECU 20 is formed by, for example, a CPU, ROM, RAM, and a data bus that connects these together, and performs parking assist control described below according to a program stored in the ROM.

With parking assist control, the ECU 20 calculates a parking path to a target parking position based on the image captured by the back monitor camera 16 mounted on the rear portion of the vehicle, the steering angle detected by the steering angle sensor 12, and the vehicle speed detected by the vehicle speed sensor 14. Then, the ECU 20 displays this parking path on the display 32 and controls the steering angle control motor 56 to realize this parking path when the vehicle is driven in reverse during a parking operation.

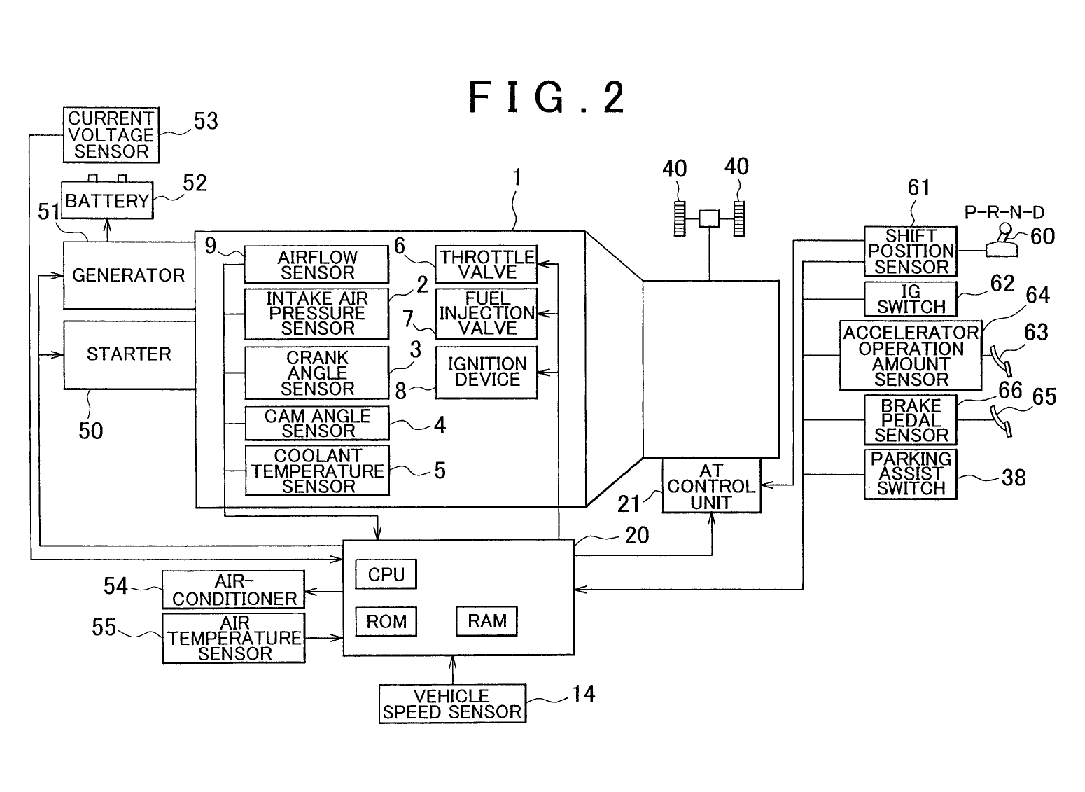

Next, idling stop control according to the example embodiment will be described with reference to FIGS. 2 to 4. Idling stop control performs automatic stop control and restart control of an internal combustion engine 1 based on various signals received by the ECU 20.

First, the system structure of the internal combustion engine 1 according to the example embodiment will be described with reference to FIG. 2. The internal combustion engine 1 is a multiple cylinder engine, for example. The internal combustion engine 1 is provided with an airflow meter (i.e., an airflow sensor) 9 that detects an intake air amount, an intake air pressure sensor 2 that detects an intake air pressure, a crank angle sensor 3 for calculating the engine speed and the like, a cam angle sensor 4 that determines the rotation angle of a camshaft, and a coolant temperature sensor 5 that detects the temperature of coolant (i.e., coolant temperature) in the internal combustion engine 1. The detection results of these sensors are received by the ECU 20.

The internal combustion engine 1 also includes a throttle valve 6 that regulates the intake air amount by opening and closing, a fuel injection valve 7 that injects fuel into a combustion chamber, and an ignition device 8 that ignites a mixture of the intake air and fuel. The throttle valve 6, the fuel injection valve 7, and the ignition device 8 are all controlled by the ECU 20.

Moreover, the internal combustion engine 1 is provided with a starter 50 that uses a battery 52 as a power supply. The starter 50 is driven by start control from the ECU 20. The internal combustion engine 1 is also provided with a generator 51. The generator 51 generates electric power from the driving force of the internal combustion engine 1. The generated electric power is used to charge the battery 52, as well as operate other electronic components. A current voltage sensor 53 detects the charge-discharge current and voltage of the battery 52. Also, the detection results are received by the ECU 20.

An air-conditioner 54 controls the temperature of the air inside the vehicle. Also, an air temperature sensor 55 detects the air temperature inside the vehicle, and the results are received by the ECU 20.

An AT control unit 21 controls an automatic transmission, not shown, according to a shift position of a shift lever 60 detected by a shift position sensor 61. In this example embodiment, the shift positions include a “P” (park range) position that is a non-driving position, an “N” (neutral range) position, a “D” (drive range) position that is a driving position, and an “R” (reverse range) position. When the shift lever 60 is in the “P” and “N” positions, the automatic transmission is controlled such that the driving force of the internal combustion engine 1 is not transmitted to wheels 40. When the shift lever 60 is in the “D” and “R” positions, the automatic transmission is controlled such that the driving force of the internal combustion engine 1 is transmitted to the wheels 40 so that the vehicle advances forward and backward, respectively.

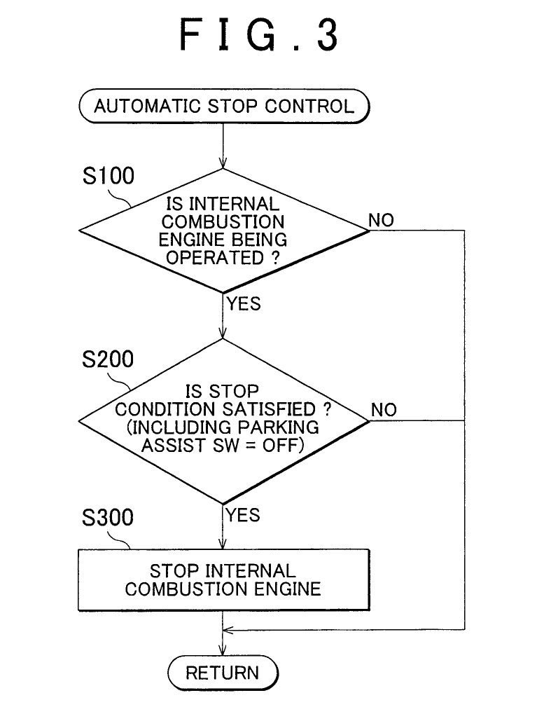

An IG switch 62 detects a starting operation by the driver. Also, an accelerator operation amount sensor 64 and a brake pedal sensor 66 detect an operation amount or operation of an accelerator pedal 63 and a brake pedal 65. The detection results are received by the ECU 20. (Operation of the accelerator pedal 63 and the brake pedal 65 is described as the accelerator pedal 63 and the brake pedal 65 being on (i.e., depressed) or off (i.e., not depressed)). Next, automatic stop control executed by the ECU 20 in this example embodiment will be described with reference to FIG. 3. In this example embodiment, the automatic stop control is repeatedly executed in predetermined cycles from the time the IG switch 62 is turned on until the IG switch 62 is turned off.

When the automatic stop control is executed, the ECU 20 first determines in step S 100 whether the internal combustion engine 1 is operating. If it is determined that the internal combustion engine 1 is not operating, (i.e., NO in step S100), this cycle of the control ends.

On the other hand, if it is determined that the internal combustion engine 1 is operating (i.e., YES in step S100), the ECU 20 determines in step S200 whether a predetermined stop condition is satisfied. Here, the stop condition includes the conditions that i) the vehicle speed be zero, ii) the accelerator pedal 63 be off (i.e., not be being depressed), iii) the brake pedal 65 be on (i.e., be being depressed), iv) the state-of-charge (SOC) of the battery 52 be equal to or greater than a predetermined amount, as well as that v) parking assist control not be being performed.

Here, the determination as to whether parking assist control is being performed is made according to whether the parking assist switch 38 is on or off. That is, if the parking assist switch 38 is on, it is determined that parking assist control is being performed, and if the parking assist switch 38 if off, it is determined that parking assist control is not being performed. However, even if the parking assist switch 38 is turned on, if a predetermined period of time or longer has since passed or if the vehicle has since travelled a predetermined distance or more, the parking assist switch 38 is automatically turned off or it is determined that parking assist control is not being performed even if the parking assist switch 38 is on.

If it is determined that the stop condition is not satisfied (i.e., NO in step S200), the internal combustion engine 1 should not be stopped, so this cycle of the control ends. On the other hand, if it is determined that the stop condition is satisfied (i.e., YES in step S200), then the internal combustion engine 1 is stopped in step S300, and then this cycle of the control ends.

In step S300, the throttle valve 6 is closed so that the intake air amount is reduced to zero, and fuel injection and ignition are stopped, for example.

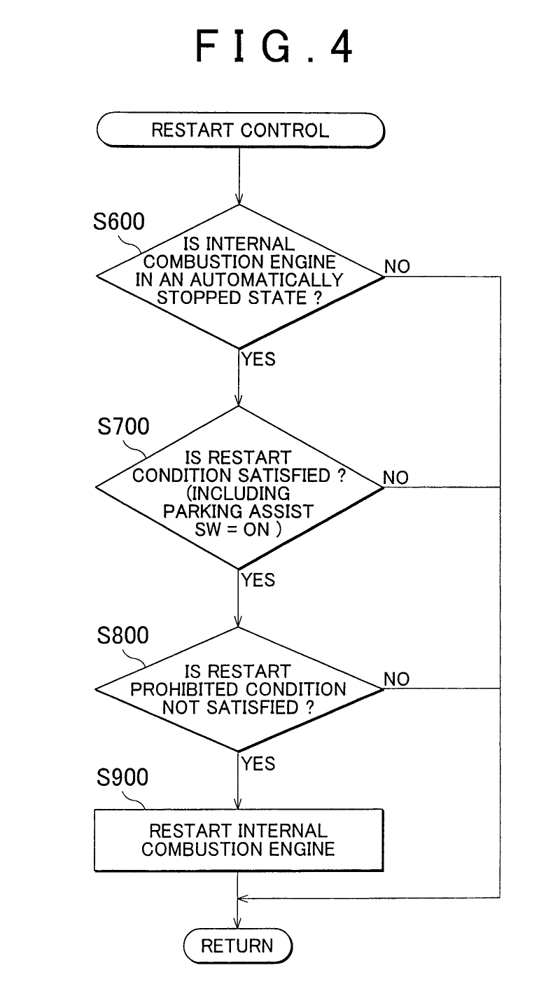

Next, restart control executed by the ECU 20 according to this example embodiment will be described with reference to FIG. 4. In this example embodiment, restart control is repeatedly executed in predetermined cycles from the time the IG switch 62 is turned on until the IG switch 62 is turned off.

When restart control is executed, the ECU 20 first determines in step S600 whether the internal combustion engine 1 is automatically stopped (also referred to as being in an automatically stopped state). If it is determined that the internal combustion engine 1 is not automatically stopped (i.e., in an automatically stopped state) (i.e., NO in step S600), this cycle of the control ends.

On the other hand, if it is determined that the internal combustion engine 1 is automatically stopped (i.e., in an automatically stopped state) (i.e., YES in step S600), the ECU 20 determines in step S700 whether a predetermined restart condition is satisfied. Here, the restart condition is satisfied when the parking assist switch 38 is on, and the accelerator pedal 63 is on (i.e., being depressed) or the brake pedal is off (i.e., is not being depressed) or the SOC of the battery 52 is equal to or less than a predetermined amount, or the like.

If it is determined that the restart condition is not satisfied (i.e., NO in step S700), the internal combustion engine 1 should remain automatically stopped, so this cycle of the control ends. On the other hand, if it is determined that the restart condition is satisfied (i.e., YES in step S700), it is determined in step S800 whether a restart prohibited condition is not satisfied.

Here, the restart prohibited condition is a condition that the shift lever be shifted from the “N” position to the “D” position with the brake pedal 65 off (i.e., not being depressed). If this kind of condition is satisfied (i.e., NO in step S800), the internal combustion engine 1 is prohibited from being restarted until the brake pedal 65 is depressed, even if the start condition is satisfied, in order to prevent the vehicle from suddenly taking off as a result of the internal combustion engine 1 restarting. Then this cycle of the control ends.

On the other hand, if the restart prohibited condition is not satisfied (i.e., YES in step S800), the internal combustion engine 1 is restarted in step S900, and then this cycle of the control ends.

In step S900, the ECU 20 first drives the starter 50 to crank the internal combustion engine 1, and then opens the throttle valve 6 and controls the fuel injection valve 7 to inject fuel and controls the ignition device 8 to start ignition.

The control apparatus for the internal combustion engine 1 according to this example embodiment is able to yield the operational effects described below.

(1) In this example embodiment, the stop condition of the internal combustion engine 1 in the automatic stop control includes the condition that parking assist control not be being executed. Therefore, the internal combustion engine 1 will not automatically stop when parking assist control is being executed. Accordingly, the internal combustion engine 1 is inhibited from being stopped against the intention of the driver while parking assist is being performed, thereby enabling a decrease in drivability to be inhibited.

(2) In this example embodiment, the determination as to whether parking assist control is being performed is made based on whether the parking assist switch 38 is on or off. Therefore, when the parking assist switch 38 is on, the internal combustion engine 1 will not automatically stop. Accordingly, an automatic stop can be inhibited from the stage before the vehicle actually shifts to an operation for parking, e.g., from the stage in which a target parking position for parking the vehicle is calculated, after the parking assist switch 38 is turned on, thus enabling a decrease in drivability to be better inhibited.

(3) In this example embodiment, even if the parking assist switch 38 is turned on, if a predetermined period of time or longer has since passed or if the vehicle has since travelled a predetermined distance or more, it is determined that parking assist is not being performed. Therefore, for example, idling stop control can be performed to reduce fuel consumption, even if the driver turns on the parking assist switch 38 but then changes his or her mind and decides to continue driving but forgets to turn off the parking assist switch 38, for example.

(4) In this example embodiment, if there is a request to start parking assist control, the internal combustion engine 1 is restarted. Therefore, the intent of the driver to perform parking assist control can be given priority over reducing fuel consumption by automatically stopping the internal combustion engine 1, thus enabling a decrease in drivability to be inhibited.

(5) In this example embodiment, even if there is a request to start parking assist control, if the restart prohibited condition in which the internal combustion engine 1 should not be restarted is satisfied, the internal combustion engine 1 will not be restarted. Therefore, priority can be given to the stability of vehicle behavior and the like over an intention of the driver to perform parking assist control.

The control apparatus for an internal combustion engine according to the invention may also be carried out in the modes described below.

In the example embodiment described above, the start control of the internal combustion engine 1 that is used starts fuel injection and ignition after driving the starter 50, but the start control of the internal combustion engine 1 is not limited to this. For example, start control that starts a stopped internal combustion engine by injecting fuel into a combustion chamber of the internal combustion engine and igniting that fuel, or start control that starts an internal combustion engine using power from a motor-generator capable of driving the engine, may also be used.

In the example embodiment described above, an automatic transmission is used as the transmission, but the transmission is not limited to this. For example, a manual transmission or a continuously variable transmission or the like may be used. Also, when the invention is applied to a vehicle provided with a manual transmission, the restart prohibited condition corresponds to a case in which the shift lever has been shifted into a position other than the “N” position without depressing the clutch pedal.

In the example embodiment described above, the stop condition of the internal combustion engine 1 includes the condition that parking assist control not be being performed. However, a stop condition of the internal combustion engine 1 that prevents the internal combustion engine from automatically stopping when the parking assist apparatus is performing parking assist is not limited to this. For example, a condition that prevents the internal combustion engine 1 from stopping may also include a condition that parking assist control be being performed or a condition that the parking assist switch 38 be on.

In the example embodiment described above, it is determined that parking assist is not being performed if a predetermined period of time or longer has passed or if the vehicle has driven a predetermined period of distance or more after the parking assist switch 38 has been turned on, but the invention is not limited to this. For example, the parking assist switch 38 may automatically turn off so the internal combustion engine 1 can be automatically stopped if a predetermined period of time or longer has passed or if the vehicle has driven a predetermined period of distance or more after the parking assist switch 38 has been turned on.

1. A control apparatus for a vehicle, comprising:
a parking assist apparatus that assists with parking of the vehicle; and
an automatic stopping device that automatically stops an internal combustion engine based on a predetermined stop condition,
wherein the control apparatus does not automatically stop the internal combustion engine when parking assist is being performed.

2. The control apparatus for a vehicle according to claim 1, further comprising:
a parking assist switch for starting parking assist, that is provided in the parking assist apparatus,
wherein the control apparatus does not automatically stop the internal combustion engine when the parking assist switch is turned on.

3. The control apparatus for a vehicle according to claim 2, wherein when a predetermined period of time or longer has passed or the vehicle has travelled a predetermined distance or more after the parking assist switch has been turned on, the control apparatus automatically stops the internal combustion engine based on another stop condition, regardless of whether the parking assist switch is on or off.

4. A control apparatus for a vehicle, comprising:
a parking assist apparatus that assists with parking of the vehicle; and
a restarting device that returns an internal combustion engine from an automatically stopped state, based on a predetermined restart condition,
wherein when the internal combustion engine is in the automatically stopped state, the control apparatus restarts the internal combustion engine when there is a request to perform parking assist.

5. The control apparatus for a vehicle according to claim 4, further comprising:
a parking assist switch for starting parking assist, that is provided in the parking assist apparatus,
wherein the control apparatus restarts the internal combustion engine when the parking assist switch is turned on.

6. The control apparatus for a vehicle according to claim 4 or claim 5, wherein the control apparatus does not restart the internal combustion engine when a predetermined restart prohibited condition is satisfied, even if there is a request to perform parking assist.
